(19) United States
(12) Patent Application Publication
(10) Pub. No.: US 2008/0036293 A1
(43) Pub. Date: Feb. 14, 2008

(54) Control Apparatus of Motor for Anti-Skid Control

(76) Inventor: Kentaro Yamamoto, Kariya-shi (JP)

Correspondence Address: BUCHANAN, INGERSOLL & ROONEY PC, POST OFFICE BOX 1404, ALEXANDRIA, VA, 22313-1404, US

(21) Appl. No.: 11/832,092

(22) Filed: Aug. 1, 2007

(30) Foreign Application Priority Data
Aug. 11, 2006 (JP) 2006-220119

(51) Int. Cl. B60T 8/48

(52) U.S. Cl. 303/116.1; 701/74

(57) ABSTRACT

A control apparatus of a motor for anti-skid control includes calculating device for calculating a vehicle body deceleration corresponding value that is a value corresponding to a vehicle body deceleration of the vehicle during an anti-skid control is executed, controlling device for: determining a target speed of a motor and controlling the speed of the motor on the basis of a target speed equivalent value that is equivalent to the determined target speed, and correcting device for correcting the target speed on the basis of a difference between a reference control pattern and an actual control pattern, when a condition indicating that the difference exists between the reference control pattern of the anti-skid control on the basis of the determined target speed and the actual control pattern of the anti-skid control that is actually executed is detected.

### CROSS REFERENCE TO RELATED APPLICATIONS

This application is based on and claims priority under 35 U.S.C. § 119 to Japanese Patent Application 2006-220119 filed on Aug. 11, 2006, the entire content of which is incorporated herein by reference.

### FIELD OF THE INVENTION

The present invention relates to a control apparatus of a motor for anti-skid control by which a speed of the motor is controlled. The motor is used for driving a pump in order to suck brake fluid from the reservoir and discharge the brake fluid to a hydraulic pressure circuit of an anti-skid control apparatus. Hereinafter, the anti-skid control may be referred to as an ABS control.

### BACKGROUND

According to a known control apparatus of the motor for ABS control, for example a control apparatus disclosed in JP2004-352163A, a drive pattern of the motor including a voltage threshold and a duration of time is determined. A voltage generated by the motor (i.e., generated by an induced electromotive force which the motor generates as a result of acting as a generator), in a state in which supply of electricity to the motor is stopped (OFF state), is compared to the voltage threshold, and the supply of the electricity to the motor has been maintained to a ON state during the duration of time. The voltage may be referred to as a generated voltage.

When the supply of electricity to the motor is stopped, and when the generated voltage is equal to or less than the voltage threshold, the supply of electricity is started (changed from the OFF state to the ON state), and the supply of electricity is maintained for the above duration of time, and after the duration of time passes, the ON state is changed to the OFF state, and the supply of electricity to the motor is stopped again. In this way the supply of electricity is ON/OFF controlled so as to form the drive pattern of the motor. Accordingly, the larger the voltage threshold is set and the longer the duration of time is, the larger the (average) speed of the motor during the ABS control (average discharging amount of the hydraulic pump) is controlled. The discharging amount is an amount per unit time.

In this configuration, when the speed of the motor is high, noises of the motor and the hydraulic pump may be increased. In order to reduce noise, the speed of the motor may be reduced.

During the ABS control, if the speed of the motor is low, the discharging amount of the hydraulic pump is reduced, as a result, the reservoir may be filled with the brake fluid. In this case, a stroke of the brake pedal may be large, and the wheel cylinder pressure may not be sufficiently reduced during a pressure reducing control of the ABS control. Further, during the ABS control, the larger the friction coefficient of the road surface on which the vehicle is running is (the larger the vehicle body deceleration during the ABS control is), the larger the amount of the brake fluid discharged to the reservoir during the pressure reducing control becomes.

Thus, during the ABS control, the known control apparatus sets a target speed of the motor to a larger value as the vehicle body deceleration is increased, and then the control apparatus controls an actual speed of the motor so as to reach the target speed. In other words, during the ABS control, the larger the vehicle body deceleration is, the larger the speed of the motor becomes.

The control pattern of the ABS control, specifically a time used for one control cycle (hereinafter referred to as a skid interval), an increasing amount (hereinafter referred to as a reservoir fluid increase amount) of the brake fluid amount within the reservoir during the pressure reducing control, depends on the friction coefficient of the road surface (a vehicle body deceleration during the ABS control).

Thus, a relation between the vehicle body deceleration during the ABS control and the reference control pattern of the ABS control (a reference skid interval, a reference reservoir fluid increase amount and the like) can be obtained through an experimental test, a simulation and the like. Further, a discharging amount of the pump appropriate for a certain control pattern of the ABS control (appropriate speed of the motor) can be determined. Thus, the target speed of the motor, which is determined on the basis of the vehicle body deceleration as disclosed in JP2004-352163A, is determined to a value appropriate for the reference control pattern of the ABS control on the basis of the vehicle body deceleration.

However, the control pattern of the ABS control may vary depending on various reasons other than the abovementioned friction coefficient of the road surface. For example, even when the friction coefficient of the road surface is stable, when a depression force of the brake pedal is increased, the time for pressure increasing control is shortened, and the skid interval tends to be shortened. Specifically, during the ABS control, when the depression force of the brake pedal is larger than a value assumed on the basis of the reference control pattern, the actual skid interval becomes shorter than the reference skid interval. In this case, because the frequency of the pressure reducing control is increased, an average amount of the brake fluid discharged to the reservoir is increased. Thus, the target speed of the motor may be corrected to a large value.

Further, when the friction coefficient of the road surface is rapidly decreased, within a short time period after the rapid decrease of the friction coefficient, as the rapid decrease of the wheel cylinder pressure during the pressure reducing control, a large amount of the brake fluid is discharged to the reservoir. Specifically, after the friction coefficient of the road surface is rapidly decreased, an actual reservoir fluid increase amount becomes larger than the reference reservoir fluid increase amount. In this case, the target speed may be corrected to a large value.

Thus, the actual control pattern of the ABS control may differ from the reference control pattern of the ABS control on the basis of the friction coefficient on the road surface (vehicle body deceleration during the ABS control). In this case, the target speed of the motor may also be corrected. However, according to the known apparatus, because the target speed of the motor is not corrected, the target speed of the motor may differ from the appropriate value.

A need thus exists to provide a control apparatus of the motor for ABS control by which a target speed of the motor (corresponding to the target discharging amount of the pump) is stably set to an appropriate value, and the speed of the motor is stably maintained to an appropriate value.

### SUMMARY OF THE INVENTION

According to an aspect of the present invention, a control apparatus of a motor for anti-skid control applied to an anti-skid control apparatus for executing an anti-skid control executing a pressure reducing control for reducing wheel cylinder pressure at a wheel when a tendency toward a locking exists at the wheel and a pressure increasing control for increasing the wheel cylinder pressure when the tendency toward the locking at the wheel is eliminated by means of the pressure reducing control, the anti-skid control being performed in accordance with a reference control pattern determined based on a vehicle body deceleration, the pressure reducing control and the pressure increasing control being executed for plural control cycles, and the control apparatus of the motor for anti-skid control controlling the speed of the motor for driving a pump discharging the brake fluid, which is drained into a reservoir when the pressure reducing control for reducing the wheel cylinder pressure is executed, into a hydraulic pressure circuit of the anti-skid control apparatus includes calculating means for calculating a vehicle body deceleration corresponding value that is a value corresponding to a vehicle body deceleration of the vehicle during the anti-skid control is executed, controlling means for determining a target speed of the motor on the basis of a characteristic where the brake fluid drained into the reservoir is increased as the calculated vehicle body deceleration corresponding value is increased, and controlling the speed of the motor on the basis of a target speed equivalent value that is equivalent to the determined target speed, and correcting means for correcting the target speed on the basis of a difference between the reference control pattern and an actual control pattern, when a condition indicating that the difference exists between the reference control pattern and the actual control pattern of the anti-skid control that is actually executed is detected.

According to an another aspect of the present invention, a hydraulic brake apparatus includes an anti-skid control apparatus for executing an anti-skid control executing a pressure reducing control for reducing wheel cylinder pressure at a wheel when a tendency toward a locking exists at the wheel and a pressure increasing control for increasing the wheel cylinder pressure when the tendency toward the locking at the wheel is eliminated by means of the pressure reducing control, the pressure reducing control and the pressure increasing control being executed for plural control cycles, a pump discharging the brake fluid, which is drained into a reservoir when the pressure reducing control for reducing the wheel cylinder pressure is executed, into a hydraulic pressure circuit of the anti-skid control apparatus, a motor for driving the pump, calculating means for calculating a vehicle body deceleration corresponding value that is a value corresponding to a vehicle body deceleration of the vehicle during the anti-skid control is executed, controlling means for: determining a target speed of the motor on the basis of a characteristic where the brake fluid drained into the reservoir is increased as the calculated vehicle body deceleration corresponding value is increased; and controlling the speed of the motor on the basis of a target speed equivalent value that is equivalent to the determined target speed, and correcting means for correcting the target speed on the basis of a difference between a reference control pattern and an actual control pattern, when a condition indicating that the difference exists between the reference control pattern of the anti-skid control on the basis of the determined target speed and the actual control pattern of the anti-skid control that is actually executed is detected.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a schematic diagram of a vehicle to which an ABS control apparatus including a control apparatus for a motor for ABS control related to an embodiment of the invention is mounted;

FIG. 2 illustrates a schematic diagram of a brake fluid pressure controlling portion illustrated in FIG. 1;

FIG. 3 illustrates a schematic diagram of a drive circuit for controlling the motor illustrated in FIG. 2;

FIG. 4 illustrates a graph indicating an example of a drive pattern of the motor;

FIG. 5 illustrates a flowchart indicting a routine for a motor control start/end determination executed by a CPU indicated in FIG. 1;

FIG. 6 illustrates a flowchart indicating a routine for the motor control executed by the CPU indicated in FIG. 1;

FIG. 7 illustrates a flowchart indicating a routine for setting a skid interval executed by the CPU indicated in FIG. 1;

FIG. 8 illustrates a flowchart indicating a routine for calculating an increasing amount of brake fluid in a reservoir during a pressure reducing control executed by the CPU indicated in FIG. 1;

FIG. 9 illustrates a flowchart indicating a routine for determining a target discharging amount and a voltage threshold executed by the CPU indicated in FIG. 1;

FIG. 10 illustrates a time chart indicating an example in a case where the target discharging amount is corrected on the basis of a comparison result between a skid interval and a reference skid interval; and

FIG. 11 illustrates a time chart indicating an example in a case where the target discharging amount is corrected on the basis of a comparison result between a reservoir fluid increase amount and a reference reservoir fluid increase amount.

### DETAILED DESCRIPTION

An embodiment of a control apparatus for controlling a motor for ABS control will be explained in accordance with the attached drawings.

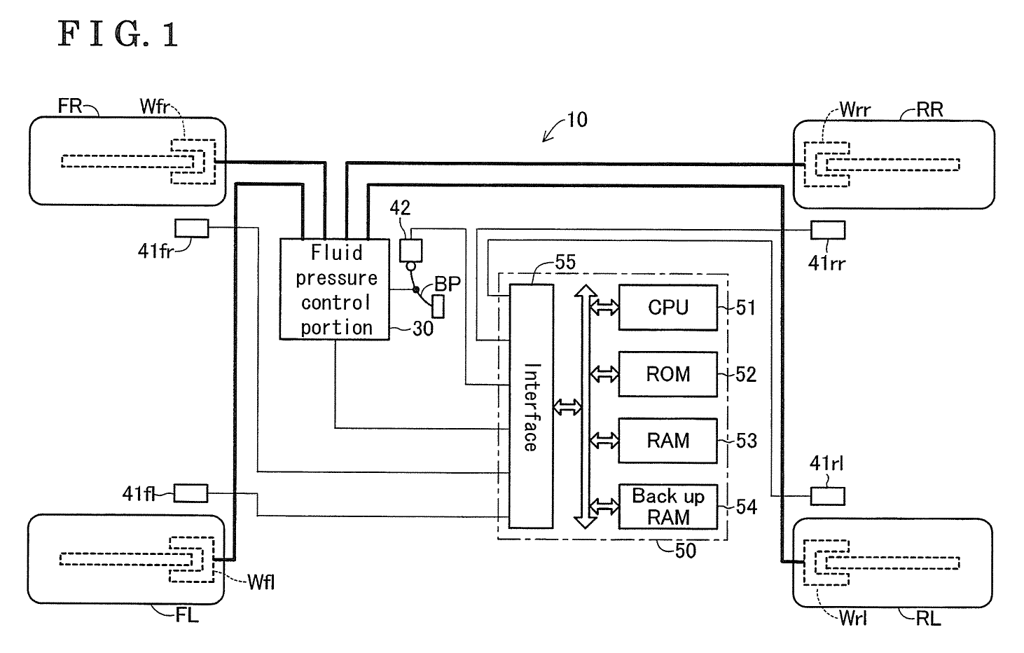

FIG. 1 illustrates a schematic configuration of a vehicle to which an ABS control apparatus 10 (anti-skid control apparatus) is mounted. The ABS control apparatus 10 includes a control apparatus for controlling the motor for ABS control related to the embodiment of the present invention. The ABS control apparatus 10 further includes a brake fluid pressure controlling portion 30 (e.g., a hydraulic brake apparatus) for generating a braking force by use of brake fluid pressure at each wheel.

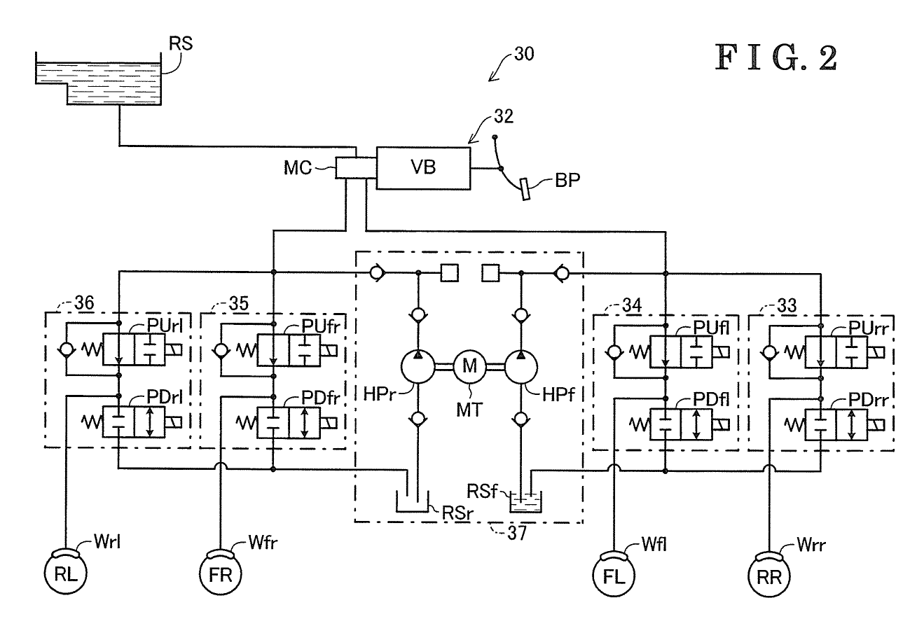

FIG. 2 illustrates a schematic configuration of the brake fluid pressure controlling portion 30. As shown in FIG. 2, the brake fluid pressure controlling portion 30 is configured of a two-conduits system including a first conduit system related to wheels RR and FL and a second conduit system related to wheels FR and RL. In other words, the brake fluid pressure controlling portion 30 is configured of a cross (X) conduit system.

The brake fluid pressure controlling portion 30 includes a brake fluid pressure generating portion 32, a RR brake fluid pressure adjusting portion 33, a FL brake fluid pressure adjusting portion 34, a FR brake fluid pressure adjusting portion 35, a RL brake fluid pressure adjusting portion 36 and a brake fluid circulating portion 37. Specifically, the brake fluid pressure generating portion 32 generates brake fluid pressure in accordance with an operation force at a brake pedal BP, the RR brake fluid pressure adjusting portion 33 is for adjusting the brake fluid pressure provided to a wheel cylinder Wrr located at a wheel RR, the FL brake fluid pressure adjusting portion 34 is for adjusting the brake fluid pressure provided to a wheel cylinder Wfl located at a wheel FL, the FR brake fluid pressure adjusting portion 35 is for adjusting the brake fluid pressure provided to a wheel cylinder Wfr located at a wheel FR, and the RL brake fluid pressure adjusting portion 36 is for adjusting the brake fluid pressure provided to a wheel cylinder Wrl located at a wheel RL.

The brake fluid pressure generating portion 32 is comprised of a vacuum booster VB and a master cylinder MC connected to the vacuum booster VB. Because a known configuration and a known actuation may be applied to each of the master cylinder MC and the vacuum booster VB, detailed explanations are omitted here.

The RR brake fluid pressure adjusting portion 33 includes a pressure increasing valve PUrr and a pressure reducing valve PDrr. Specifically, the pressure increasing valve PUrr is a two port and two-position switchover normally opened liner solenoid valve, and the pressure reducing valve PDrr is a two port and two-position switchover normally closed solenoid valve. The FL brake fluid pressure adjusting portion 34, the FR brake fluid pressure adjusting portion 35 and the RL brake fluid pressure adjusting portion 36 are configured in the same manner as the RR brake fluid pressure adjusting portion 33. Specifically, the FL brake fluid pressure adjusting portion 34 includes a pressure increasing valve PUfl and a pressure reducing valve PDfl, the FR brake fluid pressure adjusting portion 35 includes a pressure increasing valve PUfr and a pressure reducing valve PDfr, and the RL brake fluid pressure adjusting portion 36 includes a pressure increasing valve PUrl and a pressure reducing valve PDrl.

The brake fluid circulating portion 37 includes a DC motor MT and two hydraulic pumps HPf and HPr, which are simultaneously driven by the DC motor MT. The hydraulic pump HPf sucks the brake fluid from a reservoir RSf that is refluxed from the pressure reducing valves PDrr and PDfl, and the suctioned brake fluid is provided to the upper portions of the RR brake fluid pressure adjusting portion 33 and the FL brake fluid pressure adjusting portion 34.

In the same manner as the hydraulic pump HPf, the hydraulic pump HPr sucks the brake fluid from the reservoir RSr refluxed from the pressure reducing valves PDfr and PDrl, and the suctioned brake fluid is provided to the upper portions of the FR brake fluid pressure adjusting portion 35 and the RL brake fluid pressure adjusting portion 36.

As illustrated in FIG. 1, the ABS control apparatus 10 further includes wheel speed sensors 41fl, 41fr, 41rl and 41rr at each wheel. The ABS control apparatus 10 further includes a brake switch 42 and an ECU (electronic control unit) 50 (e.g. the hydraulic brake apparatus).

The ECU 50 is a microcomputer having a CPU 51, a ROM 52, a RAM 53, a backup RAM 54 and an interface 55. These elements are connected by means of a bus.

The interface 55 is connected to wheel speed sensors 41** and the brake switch 42, and signals are supplied from the wheel speed sensors 41** and the brake switch 42 to the CPU 51 via the interface 55, at the same time, in accordance with the instruction of the CPU 51, a drive signal is outputted to the solenoid valve (the pressure increasing valves PU** and the pressure reducing valves PD**) of the brake hydraulic pressure control unit 30 and the motor MT.

Each abbreviation “**” added to the end of each parameter explains a comprehensive notation of “fl” indicating the front left wheel, “fr” indicating the front right wheel, “rl” indicating the rear left wheel or “rr” indicating the rear right wheel. For example, the pressure increasing valve PU** comprehensively indicates the front left wheel pressure increasing valve PUfl, the front right wheel pressure increasing valve PUfr, the rear left wheel pressure increasing valve PUrl and the rear right wheel pressure increasing valve PUrr.

The ABS control apparatus 10 related to the embodiment of the present invention executes one of the known ABS controls in order to reduce the chances of the wheel locking upon the braking operation. In the embodiment, as the ABS control, the control cycle including a pressure reducing control, a pressure maintaining control and a pressure increasing control, is repeated.

(Description of Speed Control of the Motor MT)

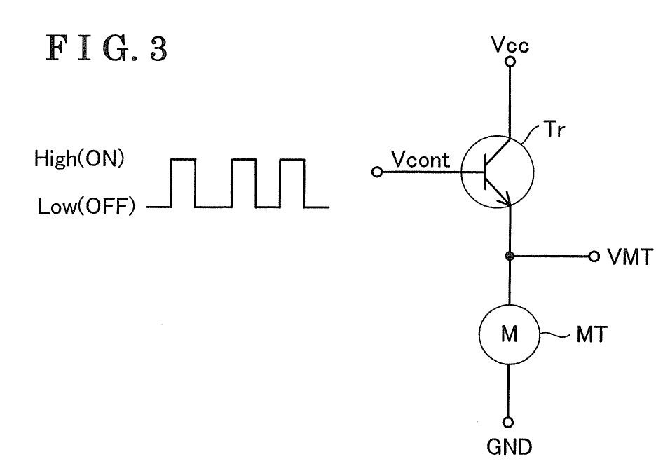

Speed control of the motor MT by means of the ABS control apparatus, which includes a control apparatus of the motor for ABS control related to the embodiment of the present invention having above-mentioned configuration, will be explained. The ABS control apparatus controls the speed of the motor by use of a power transistor Tr. The power transistor Tr is embedded in the electronic control unit 50 and functions as a switching element illustrated in FIG. 3.

Specifically, as illustrated in FIG. 3, the power transistor Tr is connected at a collector terminal thereof to a power source of the vehicle (voltage Vcc), at the same time, is connected at an emitter terminal thereof to one terminal of the motor MT. The other terminal of the motor MT is connected to the ground (Voltage GND). Further, to a base terminal of the power transistor Tr, a motor control signal Vcont generated on the basis of an instruction of the ABS control apparatus (CPU51) is applied.

The motor control signal Vcont is generated so as to reach a High level or a Low level as illustrated in FIG. 3, and the power transistor Tr is turned on (On state) when the motor control signal Vcont reaches the High level, and the power transistor Tr is turned off (Off state) when the motor control signal Vcont is in the Low level. In other words, when the motor control signal Vcont reaches the High level, the voltage Vcc is applied to the motor MT in order to drive hydraulic pumps HPf and HPr (a state where the electric power is supplied to the motor MT, hereinafter referred to as the ON state). On the other hand, when the motor control signal Vcont is in the Low level, the voltage Vcc is not applied to the motor MT (a state where the electric power is not supplied to the motor MT, hereinafter referred to as the OFF state).

Accordingly, a voltage between motor terminals VMT, which indicates the voltage between the two terminals of the motor MT (see FIG. 3) becomes the voltage Vcc constant when the motor MT is in the ON state. On the other hand, when the motor MT is in the OFF state, the voltage between motor terminals VMT becomes a voltage generated by the motor MT. The voltage generated by the motor MT is a voltage generated by the induced electromotive force at the motor MT when the motor MT serves as a power generator. The voltage reduces in accordance with the reduction of the speed of the motor rotated due to the inertia thereof, and the voltage generated by the motor MT reaches zero when the speed of the motor MT reaches zero.

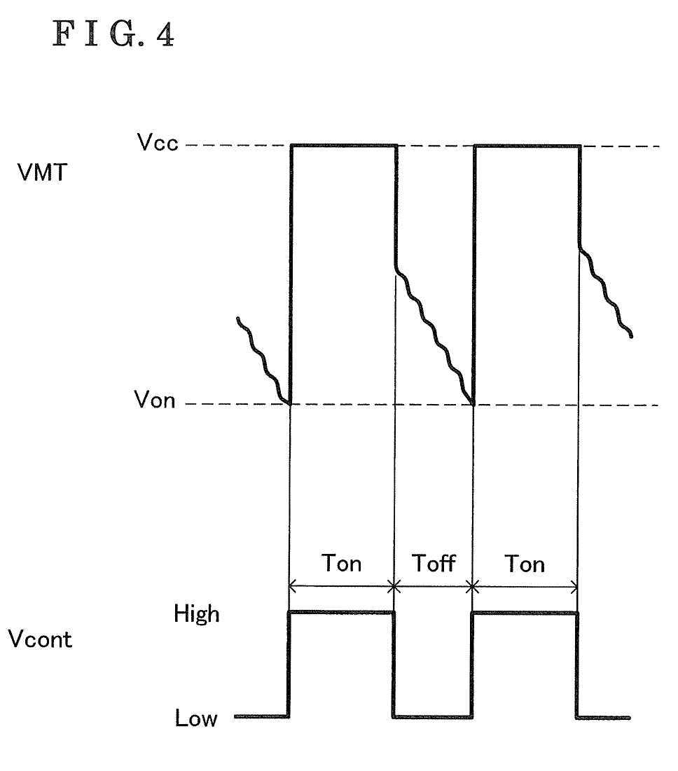

As illustrated in FIG. 4, in accordance with the decrease of the speed of the motor MT rotated due to the inertia thereof when the motor MT is in the OFF state, when the voltage between motor terminals VMT (generated voltage) is equal to or lower than a voltage threshold Von, which is determined or changed on the basis of target discharging amounts qreq (corresponding to a target speed equivalent value) of hydraulic pumps HPf and HPr, the ABS control apparatus switches the motor MT from the OFF state to the ON state, maintains the motor MT to be in the ON state during an ON time period Ton (in this example, the ON time period is constant), and drives the hydraulic pumps HPf and HPr. After the hydraulic pumps HPf and HPr are driven, the motor MT is changed from the ON state to the OFF state in order to stop the drives of the hydraulic pumps HPf and HPr.

The ABS control apparatus executes the On/Off controls of the electric power supplied to the motor MT by repeating the drive pattern of the motor comprised of the voltage threshold Von and the ON time period Ton. And then the speed of the motor MT (speeds of the hydraulic pumps HPf and HPr) is controlled in a manner where the actual discharging amount of each of the hydraulic pumps HPf and HPr becomes equal to the target discharging amount qreq. The time period in which the motor is maintained to be in the OFF state is referred to as an OFF time period Toff (see FIG. 4).

(Actual Operation)

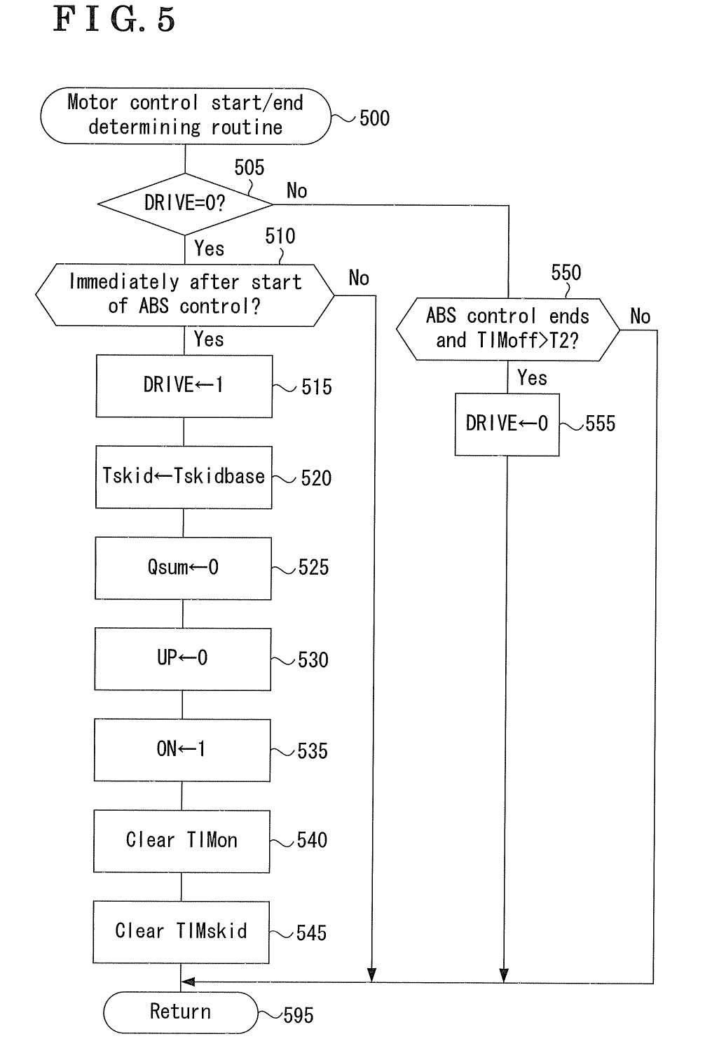

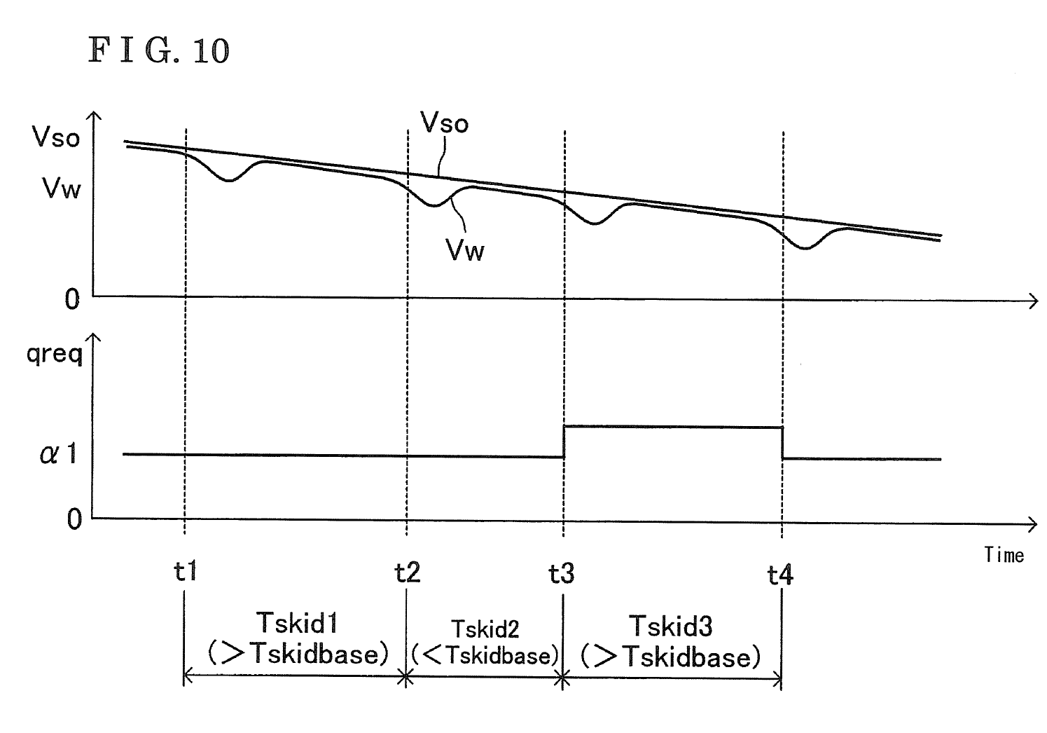

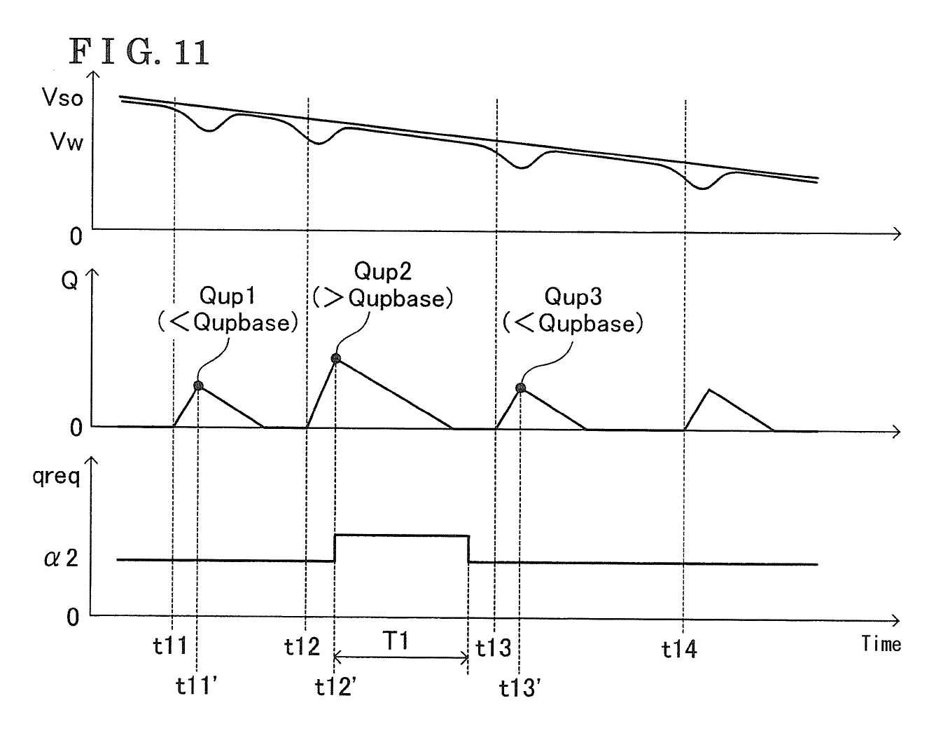

An actual operation of the ABS control apparatus will be explained in accordance with flowcharts illustrated in FIGS. 5 through 9 indicating routines executed by the CPU 51 of the electronic control unit 50 and time charts indicated in FIGS. 10 and 11.

After the routine illustrated in FIG. 4 is executed, the CPU 51 repeatedly executes a motor control start/end determining routine illustrated in FIG. 5 each time a predetermined time passes. Thus, at a predetermined timing, the CPU 51 starts a process from Step 500 and then proceeds to Step 505. In Step 505, the CPU 51 determines whether or not a flag DRIVE is “0”. At this point, the flag DRIVE “1” indicates that a motor control has been executed, and the flag DRIVE “0” indicates that the motor control is not executed.

For example, when the motor control is not executed, and when a motor control start condition is not fulfilled, the flag DRIVE is “0”. Accordingly, the CPU 51 determines “Yes” in Step 505 and proceeds to Step 510. In Step 510, the CPU 51 determines whether or not the motor control start condition is fulfilled. In this embodiment, the motor control start condition is fulfilled when the ABS control is started.

At this point, because the motor control start condition is not fulfilled, the CPU 51 determines “No” in Step 510 and proceeds to Step 595. In Step 595, the routine is temporally terminated. The above operation will be explained until the motor control start condition is fulfilled.

Next, a case where the ABS control is started, in other words a case where the motor control start condition is fulfilled, will be explained. In this case, the CPU 51 determines “Yes” in Step 510 and proceeds to Step 515. In Step 515, the CPU 51 changes the flag DRIVE from “0” to “1”.

Then, the CPU 51 executes the processes in Steps 520 through 545 and initializes parameters and the flags used for the motor control. Specifically, in Step 520, the CPU 51 executes an initializing operation by setting a skid interval Tskid (corresponding to an actual interval) to a reference skid interval Tskidbase (constant and corresponding to a reference interval). The skid interval Tskid is an actual time period used for one control cycle of the ABS control.

In Step 525, the CPU 51 initially sets an integration value Qsum to “0”. The integration value Qsum is used for calculating reservoir fluid increase amount Qup, which is an actual increase amount of the brake fluid amount (total amount) within the reservoirs RSf and RSr during a pressure reducing control. The actual increase amount is an actual increase amount of the brake fluid amount (total amount) from a start to an end of the pressure decrease control.

In Step 530, the flag UP is initialized to “0”. Because the reservoir fluid increase amount Qup is larger than a reference reservoir fluid increase amount Qupbase (corresponding to the reference increase amount), the flag UP is “1” in this Step indicates that the target discharging amount qreq is corrected to a slightly large value. On the other hand, the flag UP is “0” in this Step indicates that the target discharging amount qreq is not corrected to the slightly large value.

In Step 535, the flag ON is initialized to “1”. In this step, the flag ON “1” indicates that the motor MT is in the ON state, and the flag ON “0” indicates that the motor MT is in the OFF state.

In Step 540, an ON duration of time TIMon is cleared. The ON duration of time TIMon is obtained by a timer (not shown) embedded in the electronic control unit 50. The ON duration of time TIMon indicates a duration of time in which the motor MT is maintained to be in the ON state.

In Step 545, the one control cycle duration of time TIMskid is cleared. The one control cycle duration of time TIMskid is obtained by a timer (not shown) embedded in the electronic control unit 50. The one control cycle duration of time TIMskid indicates a duration of time of the one control cycle.

Then, because the value of the flag DRIVE is “1”, the CPU 51 determines “NO” in Step 505 and proceeds to Step 550. In Step 550, the CPU 51 determines whether or not the motor control end condition is fulfilled. In this embodiment, the motor control end condition is fulfilled when the ABS control is terminated, and when the OFF duration of time TIMoff exceeds the predetermined time T2 (constant). The OFF duration of time TIMoff is calculated by a time (not shown) embedded in the electric control unit 50. The OFF duration of time TIMoff indicates a duration of time in which the motor MT is maintained to be in the OFF state.

At this moment, because it is immediately after the motor control is started, the motor control end condition is not fulfilled. Thus, the CPU 51 determines “NO” in Step 550 and proceeds to Step 595. In Step 595, this routine is temporally terminated. The abovementioned processes are repeated until the motor control end condition is fulfilled.

On the other hand, when the motor control end condition is fulfilled, the CPU 51 determines “Yes” in Step 550 and proceeds to Step 555. In Step 555, the flag DRIVE is changed from “1” to “0”. Because the flag DRIVE is changed to “0” at this point, the CPU 51 determines “Yes” in Step 505 and proceeds to Step 510. In Step 510, the CPU 51 monitors whether or not the motor control start condition is fulfilled.

Thus, while the routine in FIG. 5 is repeated immediately after the motor control start condition is fulfilled, each value is set to each initial value, and the ON duration of time TIMon and the one control cycle duration of time TIMskid are cleared. Further, while the motor control is executed, the flag DRIVE is maintained to be “1”, and while the motor control is not executed, the flag DRIVE is maintained to be “0”.

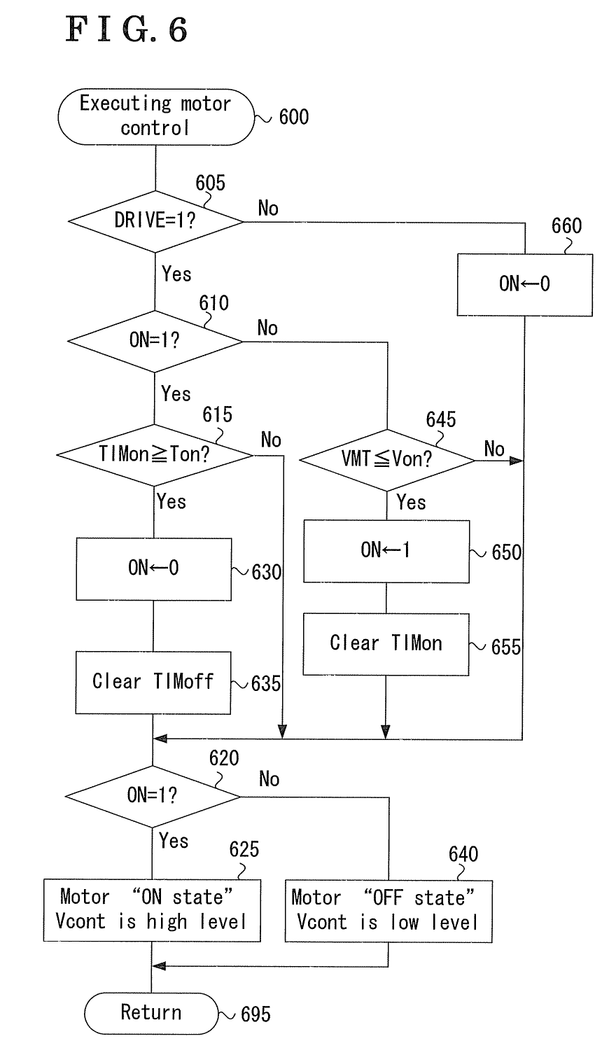

After the routine illustrated in FIG. 5 is finished, the CPU 51 repeatedly executes a motor control routine illustrated in FIG. 6 each time the predetermined time passes. Thus, at a predetermined timing, the CPU 51 starts a process from Step 600 and proceeds to Step 605. In Step 605, the CPU 51 determines whether or not the flag DRIVE is “1”.

Immediately after the motor control is started, the flag DRIVE is “1” (set in Step 515), the flag ON is “1” (set in Step 535), and the ON duration of time TIMon is cleared (set in Step 540). Accordingly, the CPU 51 determines “Yes” in Step 605 and proceeds to Step 610. In Step 610, the CPU 51 determines whether or not the flag ON is “1”. When the CPU 51 determines “Yes” in Step 610, the CPU 51 proceeds to Step 615.

In Step 615, the CPU 51 determines whether or not the ON duration of time TIMon is equal to or more than an ON time period Ton (constant). At this point, because it is immediately after the ON duration of time TIMon is cleared in the above process, TIMon is smaller than Ton. Accordingly, the CPU 51 determines “No” in Step 615 and proceeds to Step 620.

In Step 620, the CPU 51 determines whether or not the flag ON is “1”. When the CPU 51 determines “Yes” in Step 620, the CPU 51 proceeds to Step 625. In Step 625, the CPU 51 sets the motor MT to be the ON state (specifically, sets the motor control signal Vcont to be the High level).

This process is repeated until the condition in Step 615 is fulfilled. Thus, the voltage between motor terminals VMT is maintained to be the voltage Vcc constant and the drive of the hydraulic pumps HPf and HPr are continued.

On the other hand, when the ON duration of time TIMon reaches the ON time period Ton, the CPU 51 determines “Yes” in Step 615 and proceeds to Step 630. In Step 630, the CPU 51 changes the flag ON from “1” to “0” and proceeds to Step 635. In step 635, the CPU 51 clears the OFF duration of time TIMoff and proceeds to Step 620. In Step 620, the CPU 51 determines “No” and proceeds to Step 640. In Step 640, the CPU 51 changes the motor MT to be the OFF state. Specifically, the CPU 51 sets the motor control signal Vcont to the Low level. Thus, the drive of the hydraulic pumps HPf and Hpr are terminated.

After this process, because the flag ON is “0”, when the CPU 51 determines “No” in Step 610, the CPU 51 proceeds to Step 645. In Step 645, the CPU 51 determines whether or not the voltage between motor terminals VMT is equal to or less than the voltage threshold Von. The voltage threshold Von may vary moment by moment through the following routine.

At this point, because it is immediately after the motor MT is changed from the ON state to OFF state, the voltage between motor terminals VMT is larger than the voltage threshold Von. Thus, the CPU 51 determines “No” in Step 645 and proceeds to Step 620. The CPU 51 further proceeds to Step 640 and maintains the motor MT to be in the OFF state. While the motor MT is maintained to be in the OFF state, this process is continued until the voltage between motor terminals VMT reaches the voltage threshold Von. The voltage between motor terminals VMT is reduced as the speed of the motor MT reduces.

When the voltage between motor terminals VMT reaches the voltage threshold Von, the CPU 51 determines “Yes” in Step 645 and proceeds to Step 650. In Step 650, the CPU changes the flag ON from “0” to “1” and further proceeds to Step 655. In Step 655, the CPU 51 clears the ON duration of time TIMon and proceeds to Step 620. Then, the CPU 51 further proceeds to Step 625. In Step 625, the CPU 51 again changes the motor MT to be in the ON state. Accordingly, the drives of hydraulic pumps HPf and HPr are started again.

Then, because the flag ON is “1”, the CPU 51 determines “Yes” in Step 610 and proceeds to Step 615. In Step 615, the CPU 51 again monitors whether or not the ON duration of time TIMon is equal to or more than the ON time period Ton. On the basis of the result in Step 615, until the ON duration of time TIMon becomes equal to or more than the ON time period Ton, the drives of the hydraulic pumps HPf and HPr are continued again.

Thus, as the routine illustrated in FIG. 6 is repeatedly executed, the motor MT is ON/OFF controlled in a drive pattern of the motor of the voltage threshold Von, which varies moment by moment, and the constant ON time period Ton, and then the speed of the motor MT (speeds of the hydraulic pumps HPf and HPr) is controlled in proportion to the voltage threshold Von.

Further, the flag ON is maintained to be “1” while the motor MT is in the ON state, and the flag ON is maintained to be “0” while the motor MT is in the OFF state. The routine illustrated in FIG. 6 corresponds to controlling means.

When the flag DRIVE is “0” (the motor control is not executed), the CPU 51 determines “No” in Step 605 and proceeds to Step 660. In Step 660, the CPU 51 sets the flag ON to “0” and proceeds to Step 620. The CPU 51 further proceeds to Step 640 and maintains the motor MT to be in the OFF state.

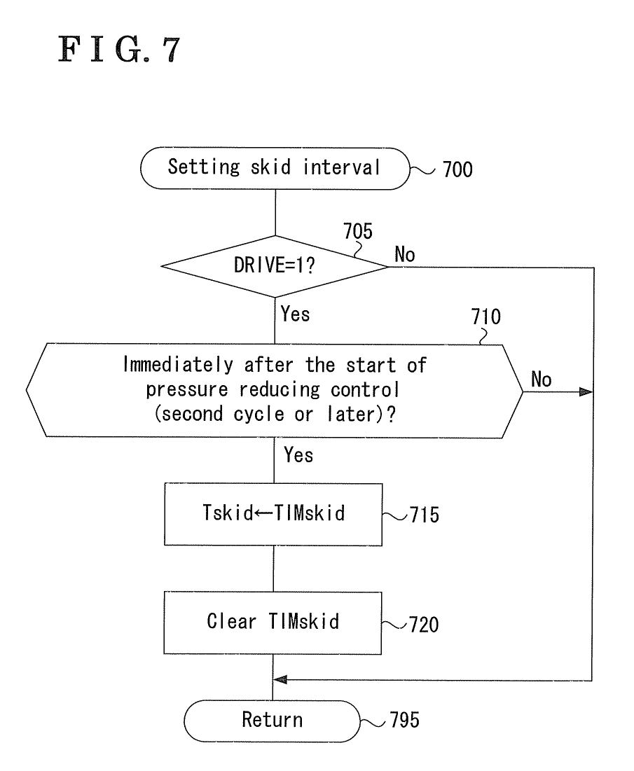

The CPU 51 repeatedly executes a routine for setting a skid interval Tskid illustrated in FIG. 7 each time a predetermined time passes after the routine illustrated in FIG. 6 is executed. Specifically, at a predetermined timing, the CPU 51 starts the process from Step 700 and proceeds to Step 705. In Step 705, the CPU 51 determines whether or not the flag DRIVE is “1”. When the CPU 51 determines “No” (determines the flag DRIVE is not “1”) in Step 705, the CPU 51 proceeds to Step 795 and temporally terminates this routine.

Specifically, when the motor control is executed, the flag DRIVE is set to “1” in Step 515 as mentioned above. Accordingly, the CPU 51 determines “Yes” in Step 705 and proceeds to Step 710. In Step 710, the CPU 51 determines whether or not the present moment is immediately after the pressure reducing control of the second cycle or later. When the CPU 51 determines “No” in Step 710, the CPU 51 proceeds to Step 795 and temporally terminates this routine.

On the other hand, when the CPU 51 determines “Yes” in Step 710 (immediately after the start the pressure reducing control of the second cycle or later), the CPU 51 proceeds to Step 715 and sets the skid interval Tskid to be equal to the one control cycle duration of time TIMskid at this point.

The one control cycle duration of time TIMskid at this point indicates an elapsed time from a point where the ABS control is started (specifically, immediately after the pressure reducing control of the first control cycle is started) (see Step 545). Thus, at this point (immediately after the pressure reducing control of the second control cycle starts), the skid interval Tskid is changed from the initial value (reference skid interval Tskidbase) set in Step 520 to the duration of time of the first control cycle.

The CPU 51 further proceeds to Step 720 and clears the one control cycle duration of time TIMskid again. Then the CPU 51 proceeds to Step 795 and terminates this routine. Then, CPU 51 determines “Yes” in Step 710 each time a new control cycle is started, and the CPU 51 further proceeds to Steps 715 and 720 and executes the processes in Steps 715 and 720.

In this way, by repeatedly executing the routine illustrated in FIG. 7, each time the control cycle of N time (N=integer number equal to or larger than 2) is started, the skid interval Tskid, which is set to be an initial value (reference skid interval Tskidbase) immediately after the ABS control is started, is renewed to be the duration of time of the control cycle of the (N−1) time so as to form a step shape.

For example, as illustrated in FIG. 10, the skid interval Tskid is set (renewed) to a value Tskid1 at a time t2 and maintained to be the value Tskid1 during a time period between the time t2 and a time t3. The skid interval Tskid is renewed to a value Tskid2 at the time t3 and maintained to the value Tskid2 during a time period between the time t3 and a time t4. The skid interval Tskid is renewed to a value Tskid3 at the time t4.

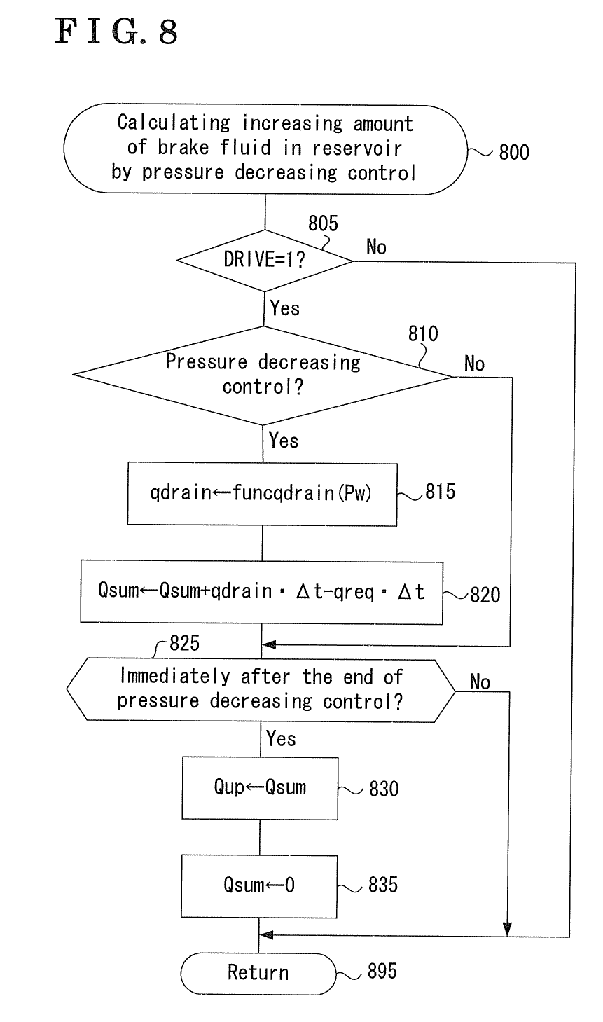

Further, after the routine illustrated in FIG. 7 is executed, the CPU 51 repeatedly executes the routine illustrated in FIG. 8 each time the predetermined time passes in order to obtain the reservoir fluid increase amount Qup.

Hereinafter each of the reservoirs RSf and RSr may simply be referred to as a reservoir. At a predetermined timing, the CPU 51 starts a process from the Step 800 and proceeds to the Step 805. In Step 805, the CPU 51 determines whether or not the flag DRIVE is “1”. When the CPU 51 determines “No” in Step 805, the CPU proceeds to Step 895 and temporally terminates this routine.

When the motor control is executed at this point, the flag DRIVE has been set to “1” in Step 515 as mentioned above. Thus, the CPU 51 determines “Yes” in Step 805 and proceeds to Step 810. In Step 810, the CPU 51 determines whether or not the pressure reducing control is executed.

If it is immediately after the ABS control is started (immediately after the pressure reducing control of the first control cycle is started), the CPU 51 determines “Yes” in Step 810 and proceeds to Step 815. In Step 815, the CPU 51 calculates the drain amount qdrain by use of a function funcqdrain having factors of wheel cylinder pressures Pw and Pw.

The drain amount qdrain indicates an amount of the brake fluid, which is drained from the pressure reducing valve PD** and flows into the reservoir during the pressure reducing control (while the pressure reducing valve PD** is in an opened state).

Because the drain amount qdrain can be calculated on the basis of the wheel cylinder pressure and an opening area (constant) of the pressure reducing valve PD**, which is in the opened state, the drain amount qdrain is calculated as a function of the wheel cylinder pressure Pw.

When the pressure reducing controls are simultaneously executed at plural wheels, the drain amount qdrain is calculated as a total of the drain amounts at the plural wheels. The wheel cylinder pressure Pw can be estimated by means of a known method.

Then, the CPU 51 proceeds to Step 820 and renews the integration value Qsum, whose initial value is set to “0” by the process in Step 525, following a formula (I) indicated below. At this point, “qdrain Δt” corresponds to a brake fluid amount flowing into the reservoir at each program executing cycle Δt, and “qreq Δt” corresponds to a brake fluid amount sucked by the hydraulic pumps HPf and HPr from the reservoir at each program executing cycle Δt. Thus, in this case, the integration value Qsum indicates an increasing amount of the brake fluid amount (reservoir fluid amount Q) within the reservoir from the starting point of the first pressure reducing control to the present moment.

Qsum=Qsum+qdrain·Δt−qreq·Δt (1)

Next, the CPU 51 proceeds to Step 825 and determines whether or not it is immediately after the pressure reducing control is ended. At this point, because it is immediately after the ABS control is stareted, the CPU 51 determines “No” in Step 825 and proceeds to Step 895. In Step 895, the CPU 51 temporally terminates this routine. This process is repeatedly executed until the first pressure reducing control is terminated. Accordingly, during the first pressure reducing control, the integration value Qsum has been renewed in Step 820.

Next, a case where the pressure reducing control at the first control cycle is terminated will be explained. In this case, the CPU 51 determines “No” in Step 810 and directly proceeds to Step 825. In Step 825, the CPU 51 determines “Yes” and then proceeds to Step 830. In Step 830, the CPU 51 sets the reservoir fluid increase amount Qup to an integration value Qsum at this point. The integration value Qsum at this point indicates the increasing amount of the reservoir fluid amount Q from the starting point to the ending point of the pressure reducing control of the first control cycle. Accordingly, the reservoir fluid increase amount Qup is set to an increasing amount of the reservoir fluid amount Q during the pressure reducing control of the first control cycle.

Then, the CPU 51 proceeds to Step 835 and sets the integration value Qsum to “0”. Then, the CPU 51 proceeds to Step 895 and temporally terminates this routine.

Hereinafter each time the pressure reducing control of a new control cycle is started, from the condition where the integration value Qsum is “0”, the processes in Steps 815 and 820 are repeatedly executed while the pressure reducing control is executed, and immediately after the pressure reducing control is terminated, the processes in Steps 830 and 835 are executed.

Thus, as the routine illustrated in FIG. 8 is repeatedly executed, each time the pressure reducing control of N time control cycle (N is an integer number equal to or greater than “1”) is terminated, the reservoir fluid increase amount Qup is renewed to an increasing amount of the reservoir fluid amount Q during the pressure reducing control of the N time control cycle so as to form a step shape.

For example, in the example illustrated in FIG. 1, the reservoir fluid increase amount Qup is set (renewed) to a value Qup1 at a time t11′ (at an ending point of the pressure reducing control of the control cycle corresponding to the time t11 through the time t12). Then, the reservoir fluid increase amount Qup is maintained to the value Qup1 during a time period between the time t11′ and a time t12′. The reservoir fluid increase amount Qup is renewed to a value Qup2 at the time t12′ (at an ending point of the pressure reducing control of the control cycle corresponding to the time period between the time t12 and the time t13). The reservoir fluid increase amount Qup is maintained to the value Qup2 during the time period between the time t12′ and a time t13′. Further, the reservoir fluid increase amount Qup is renewed to a value Qup3 at the time t13′ (at an ending point of the pressure reducing control of the control cycle corresponding to the time period between the time tl3 and the time t14).

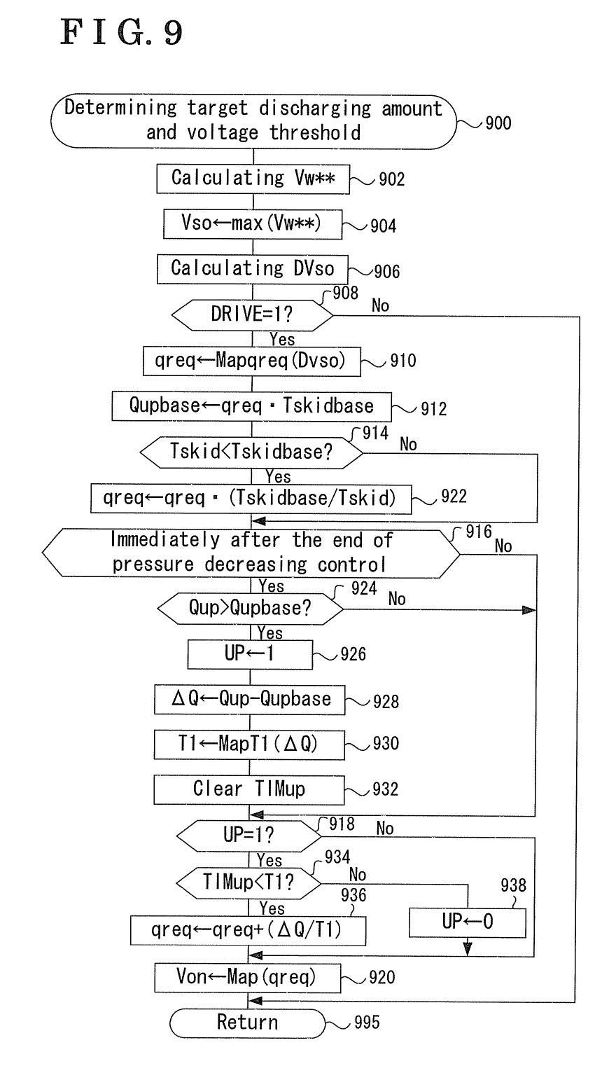

Further, the CPU 51 repeatedly executes a routine illustrated in FIG. 9 for determining a target discharging amount qreq and a voltage threshold Von, following the routine illustrated in FIG. 8, each time a predetermined time passes. Thus, at a predetermined timing, the CPU 51 starts a process from Step 900 and proceeds to Step 902. In Step 902, the wheel speed Vw** (speed of the wheels at an outer periphery thereof) is calculated on the basis of an output from a wheel speed sensor 41**.

Then, the CPU 51 proceeds to Step 904. In Step 904, the CPU 51 sets the vehicle body speed Vso to a maximum value of the wheel speed Vw** and proceeds to Step 906. In Step 906, the CPU 51 calculates a vehicle body deceleration DVso (corresponding to a vehicle body deceleration corresponding value) by time differentiating (and reversing the sign thereof) the vehicle body speed Vso. In this embodiment, Step 906 corresponds to calculating means.

Then, the CPU 51 proceeds to Step 908. In Step 908, the CPU 51 determines whether or not the flag DRIVE is “1”. When the CPU 51 determines “No” in Step 908, the CPU 51 proceeds to Step 995 and temporally terminates this routine.

If the motor control is executed at this point, the flag DRIVE has been set to “1” in Step 515. Accordingly, the CPU 51 determines “Yes” in Step 908 and proceeds to Step 910. In Step 910, the CPU 51 determines a target discharging amount qreq on the basis of the vehicle body deceleration DVso and a table Mapqreq for regulating a relation between the vehicle body deceleration DVso and the target discharging amount qreq of each hydraulic pump HPf and HPr. In this embodiment, Step 910 corresponds to determining means.

Thus, the target discharging amount qreq is determined to have a larger value as the vehicle body deceleration DVso increases. This is based upon a tendency where the larger a friction coefficient on a road surface, on which the vehicle under the ABS control is running, becomes (in other words, the larger the vehicle body deceleration DVso during the ABS control becomes), the larger the brake fluid amounts drained from the reservoirs RSf and RSr during the pressure reducing control become.

The table Mapqreq is made on the basis of a relation between the vehicle body deceleration during the ABS control and a reference control pattern of the ABS control (including a reference skid interval Tskidbase and a reference reservoir fluid increase amount Qupbase), which are pre-obtained by executing an experiment and a simulation. Specifically, the target discharging amount qreq is determined to be an appropriate value for the reference control pattern of the ABS control corresponding to the vehicle body deceleration Dvso.

Then, the CPU 51 proceeds to Step 912. In Step 912, the reference reservoir fluid increase amount Qupbase(=qreq·Tskidbase) is determined. The value determined in Step 910 is used as qreq. In the embodiment, the reference skid interval Tskidbase is a constant value.

Then, the CPU 51 proceeds to Step 914. In Step 914, the CPU 51 determines whether or not the skid interval Tskid at this point (renewed in Step 715 in the routine illustrated in FIG. 7) is shorter than the reference skid interval Tskidbase.

When the skid interval Tskid at this point is equal to or larger than the reference skid interval Tskidbase, the CPU 51 determines “No” in Step 914 and proceeds to Step 916. In Step 916, the CPU 51 determines whether or not the present moment is immediately after the pressure reducing control is ended. When the CPU 51 determines “No” in Step 916, the CPU 51 proceeds to Step 918.

On the other hand, immediately after the pressure reducing control is ended, the CPU 51 determines “Yes” in Step 916 and proceeds to Step 924. In Step 924, it is determined whether or not the reservoir fluid increase amount Qup at this point, which is renewed in Step 830 in the routine illustrated in FIG. 8, is larger than the reference reservoir fluid increase amount Qupbase.

When the reservoir fluid increase amount Qup at this point is equal to or smaller than the reference reservoir fluid increase amount Qupbase, the CPU 51 determines “No” in Step 924 and directly proceeds to Step 918.

In Step 918, the CPU 51 determines whether or not the flag UP is “1” (the initial value of the flag UP is set to “0” in Step 530). At this point, if the flag UP is “0”, the CPU 51 determines “No” in Step 918 and proceeds to Step 920.

In Step 920, the CPU 51 calculates a voltage threshold Von on the basis of the target discharging amount qreq and the table Map regulating a relation between the target discharging amount qreq and the voltage threshold Von. The CPU 51 proceeds to Step 995 and temporally terminates this routine.

In this case, the target discharging amount qreq used for determining the voltage threshold Von is a value that has been determined in Step 910 on the basis of the vehicle body deceleration DVso, and the target discharging amount qreq has not been corrected since it is determined in Step 910.

Thus, the larger the target discharging amount qreq is, the larger the voltage threshold Von is set. The voltage threshold Von is used in the determining process in Step 645 illustrated in FIG. 6. Thus, the speed of the motor MT is controlled in a manner where the discharging amount of the hydraulic pumps HPf and HPr corresponds to the target discharging amount qreq, and where the speed of the motor MT becomes larger as the target discharging amount qreq increases.

Thus, when the CPU 51 determines “No” in Step 914 and further determines “No” in Steps 916 and 924, because the target discharging amount qreq has not been corrected from the value determined on the basis of the vehicle body deceleration DVso in Step 910, the speed of the motor MT is controlled in a manner where the discharging amounts of the hydraulic pumps HPf and HPr correspond to the value determined in Step 910 on the basis of the vehicle body deceleration DVso. In this embodiment, Step 920 corresponds to controlling means.

Next, a case where the CPU 51 determines “Yes” in Step 914 will be explained. When the skid interval Tskid at this point is shorter than the reference skid interval Tskidbase, the CPU 51 determines “Yes” in Step 914 and proceeds to Step 922. In Step 922, the CPU 51 corrects the target discharging amount qreq to be a value obtained by a formula “qreq·(Tskidbase/Tskid)”. This case corresponds to “a case where a condition, in which the actual control pattern during the ABS control differs from the reference control pattern, is detected”.

Thus, as a difference between the skid interval Tskid and the reference skid interval Tskidbase, which is shorter than the skid interval Tskid, becomes larger, the target discharging amount qreq is corrected to a larger value. Then, the corrected target discharging amount qreq is used for determining the voltage threshold Von in Step 920. Thus, in this case, the speed of the motor MT is controlled so as to be higher, as a result, the tendency where the reservoir is filled with the brake fluid as the average amount of the brake fluid drained into the reservoirs RSf and RSr increases due to the short skid interval Tskid can be decreased.

As mentioned above, when the skid interval Tskid is shorter than reference skid interval Tskidbase, the target discharging amount qreq is corrected to a value that is larger than the value determined in Step 910 on the basis of the vehicle body deceleration DVso. On the other hand, when the skid interval Tskid is equal to or larger than the reference skid interval Tskidbase (and the CPU 51 determines “No” in Steps 916 and 924), the target discharging amount qreq is not corrected from the value that is determined in Step 910 on the basis of the vehicle body deceleration DVso.

In the example illustrated in FIG. 10, the vehicle body deceleration DVso is constant, and the target discharging amount qreq has been determined (set) to a value α1 in Step 910. In this case, during the time period between the time t2 and the time t3, in which the skid interval Tskid is maintained to the value Tskid1 (>Tskidbase), the target discharging amount qreq is not corrected and maintained to the value α1. Further, during the time period between the time t3 and the time t4, in which the skid interval Tskid is maintained to the value Tskid2 (<Tskidbase), the target discharging amount qreq is corrected to a value that is larger than the value α1. Then, after the time t4 at which the skid interval Tskid is maintained to the value Tskid3 (>Tskidbase), the target discharging amount qreq is not corrected and is maintained to the value α1.

Immediately after the pressure reducing control is terminated, and when the reservoir fluid increase amount Qup, which has been renewed in Step 830 of the routine illustrated in FIG. 8, is larger than the reference reservoir fluid increase amount Qupbase, the CPU 51 determines “Yes” in Steps 916 and 924 and proceeds to Step 926. In Step 926, the CPU 51 sets the flag UP to “1”.

Then, the CPU 51 proceeds to Step 928. In Step 928, the CPU 51 calculates a correction amount ΔQ (=Qup−Qupbase) and proceeds to Step 930. In Step 930, the CPU 51 calculates a correcting time period T1 on the basis of the correction amount ΔQ and a table MapT1 for regulating a relation between the correction amount ΔQ and the correcting time period T1. During the correcting time period T1, the correction of the target discharging amount qreq on the basis of the correction amount ΔQ has been continued. Thus, the larger the correction amount ΔQ is, the shorter the correcting time period T1 is set.

Then, the CPU 51 proceeds to Step 932 and clears a duration of time TIMup. The duration of time TIMup is obtained by a timer (not shown) embedded in the electronic control unit 50. The duration of time TIMup indicates a duration of time since the correction of the target discharging amount qreq has started.

Next, the CPU 51 proceeds to Step 918 and determines whether or not the flag UP is “1”. When the CPU 51 determines “Yes” in Step 918, the CPU proceeds to Step 934. In Step 934, the CPU 51 determines whether or not the duration of time TIMup is less than the correcting time period T1.

When the duration of time TIMup is less than the correcting time period T1, the CPU 51 determines “Yes” in Step 934 and proceeds to Step 936. In Step 936, the CPU 51 corrects the target discharging amount qreq to a value obtained by a formula “qreq+(ΔQ/T1)”. This case corresponds to a case where a condition indicating an actual control pattern of the ABS control differs from the reference control pattern.

Thus, the larger the difference between the reservoir fluid increase amount Qup and the reference reservoir fluid increase amount Qupbase, which is smaller than the Qup, is, the larger the target discharging amount qreq is corrected. Thus, the corrected target discharging amount qreq is used for determining the voltage threshold Von in Step 920. Accordingly, the speed of the motor MT is controlled to be larger.

The above steps are repeated until the CPU 51 determines “Yes” in Step 934. Thus, the tendency where the reservoir is filled with the brake fluid can be decreased.

Then, when the duration of time TIMup reaches the correcting time period T1, the CPU 51 determines “No” in Step 934 and proceeds to Step 938. In Step 938, the CPU 51 changes the flag UP from “1” to “0” and proceeds to Step 920 (skips Step 936). Hereinafter, because the flag UP is “0”, the CPU 51 determines “No” in Step 918 and directly proceeds to Step 920 (skips Step 936).

As mentioned above, in Step 936, immediately after the pressure reducing control is terminated, and when the reservoir fluid increase amount Qup is larger than the reference reservoir fluid increase amount Qupbase, the target discharging amount qreq is subsequently corrected during the correcting time period T1. On the other hand, immediately after the pressure reducing control is terminated, and when the reservoir fluid increase amount Qup is equal to or less than the reference reservoir fluid increase amount Qupbase (and when the CPU 51 determines “No” in Step 914), the target discharging amount qreq is not corrected from the value determined on the basis of the vehicle body deceleration DVso in Step 910.

For example, in an example illustrated in FIG. 11, the vehicle body deceleration DVso is constant, and in Step 910, the target discharging amount qreq has been set to a value α2. In this case, in the same manner as the times t11′ and t13′, immediately after the pressure reducing control is terminated, and when the reservoir fluid increase amount Qup (=Qup1, Qup3) is smaller than the reference reservoir fluid increase amount Qupbase, the target discharging amount qreq is not corrected and is maintained to the value α2. On the other hand, in the same manner as the time t12′, immediately after the pressure reducing control is terminated, and when the reservoir fluid increase amount Qup (=Qup2) is larger than the reference reservoir fluid increase amount Qupbase, during the later correcting time period T1, the target discharging amount qreq is corrected to a value that is larger than the value α2. The above steps 912 through 918 and the steps 922 through 938 correspond to correcting means.

As mentioned above, in Step 910, the target discharging amounts qre (corresponding to a target speed of the motor MT) of the hydraulic pumps HPf and HPr are essentially determined to an appropriate value for the reference control pattern of the ABS control corresponding to the vehicle body deceleration DVso by use of the table Mapqreq. The table Mapqreq is made on the basis of the relation between the vehicle body deceleration during the ABS control and the reference control pattern of the ABS control (including the reference skid interval Tskidbase and the reference reservoir fluid increase amount Qupbase). Thus, when the actual control pattern of the ABS control corresponds to the reference control pattern, the target discharging amount qre is set to an appropriate value so that the speed of the motor MT is controlled to be an appropriate value.

On the other hand, when the skid interval Tskid, which is a duration of time of one control cycle, is shorter than the reference skid interval Tskidbase, or when the reservoir fluid increase amount Qup, which is an increasing amount of the reservoir fluid amount during the pressure reducing control, is larger than the reference reservoir fluid increase amount Qupbase, the target discharging amount qre is corrected to a large value. Thus, even when the actual control pattern of the ABS control differs from the reference control pattern, the target discharging amount qre is stably maintained to be an appropriate value for the actual control pattern of the ABS control. As a result, the tendency where the reservoirs RSf and RSr are filled with the brake fluid can be decreased.

The present invention is not limited to the above-mentioned embodiment and may be modified within the scope of the present invention. For example, in the above embodiment, the target discharging amounts qre of the hydraulic pumps HPf and HPr are determined on the basis of the vehicle body deceleration Vso, and then, the speed of the motor MT is controlled on the basis of the target discharging amount qre or a corrected target discharging amount qre. However, the target speed of the motor MT may be directly determined on the basis of the vehicle body deceleration Vso, and the speed of the motor MT may be controlled on the basis of the target speed or a corrected target speed.

In the embodiment, when the reservoir fluid increase amount Qup is larger than the reference reservoir fluid increase amount Qupbase, the target discharging amount qre is corrected to a larger value during the correcting time period T1 immediately after the pressure reducing control is terminated, however, during the pressure reducing control, the correction of the target discharging amount qre may be started at a point when the integration value Qsum (an increasing amount of the reservoir fluid amount from a point when the pressure reducing control start to a present moment) exceeds the reference reservoir fluid increase amount Qupbase.

Further, in the embodiment, the voltage threshold Von is controlled in order to control the speed of the motor MT, however, the ON time period Ton may be controlled in order to control the speed of the motor MT. Further, both the voltage threshold Von and the ON time period Ton may be controlled in order to control the speed of the motor MT.

Furthermore, in the embodiment, the target discharging amounts qre of the hydraulic pumps HPf and HPr are determined on the basis of the vehicle body deceleration Vso, however, the target discharging amounts qre of the hydraulic pumps HPf and HPr may be determined on the basis of a friction coefficient of the road surface.

According to the embodiment of the present invention, the vehicle body deceleration corresponding value is the vehicle body deceleration, the friction coefficient of the road surface or the like. The reference control pattern can be obtained through the experimental test and the simulation by which the relation between the vehicle body deceleration during the ABS control and the reference control pattern (the reference skid interval, the reference reservoir fluid increase amount and the like) can be obtained. The target speed equivalent value is the target speed of the motor, the target discharging amount of the pump or the like.

In this configuration, when the actual control pattern during the ABS control differs from the reference control pattern during the ABS control on the basis of the vehicle body deceleration during the ABS control, the target speed of the motor (or the target discharging amount of the pump) is corrected. Accordingly, the target speed of the motor is stably set to an appropriate value relative to the actual control pattern during the ABS control. As a result, the speed of the motor is stably maintained to an appropriate value.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A control apparatus of a motor for anti-skid control applied to an anti-skid control apparatus for executing an anti-skid control executing a pressure reducing control for reducing wheel cylinder pressure at a wheel when a tendency toward a locking exists at the wheel and a pressure increasing control for increasing the wheel cylinder pressure when the tendency toward the locking at the wheel is eliminated by means of the pressure reducing control, the anti-skid control being performed in accordance with a reference control pattern determined based on a vehicle body deceleration, the pressure reducing control and the pressure increasing control being executed for plural control cycles, and the control apparatus of the motor for anti-skid control controlling the speed of the motor for driving a pump discharging the brake fluid, which is drained into a reservoir when the pressure reducing control for reducing the wheel cylinder pressure is executed, into a hydraulic pressure circuit of the anti-skid control apparatus, comprising:
calculating means for calculating a vehicle body deceleration corresponding value that is a value corresponding to a vehicle body deceleration of the vehicle during the anti-skid control is executed;
controlling means for determining a target speed of the motor on the basis of a characteristic where the brake fluid drained into the reservoir is increased as the calculated vehicle body deceleration corresponding value is increased, and controlling the speed of the motor on the basis of a target speed equivalent value that is equivalent to the determined target speed; and
correcting means for correcting the target speed on the basis of a difference between the reference control pattern and an actual control pattern, when a condition indicating that the difference exists between the reference control pattern and the actual control pattern of the anti-skid control that is actually executed is detected.

2. The control apparatus of the motor for anti-skid control according to claim 1, wherein, on the basis of a result of a comparison between an actual interval, which is an actual time used for a predetermined control cycle for executing the pressure increasing control after the pressure reducing control, and a reference interval used a the control cycle corresponding to the reference control pattern, when the actual interval is shorter than the reference interval, the correcting means corrects the target speed equivalent value in a manner where the larger a difference between the actual interval of a next control cycle and the reference interval is, the larger the target speed equivalent value becomes.

3. The control apparatus of the motor for anti-skid control according to claim 2, wherein the correcting means corrects the target speed equivalent value when the actual interval is equal to or less than the reference interval.

4. The control apparatus of the motor for anti-skid control according to claim 1, wherein, on the basis of a result of a comparison between an actual increase amount, which is an actual value of an increase amount of the brake fluid within the reservoir during the pressure reducing control at the predetermined control cycle, and a reference increase amount, which is an increase amount of the brake fluid within the reservoir during the pressure reducing control corresponding to the reference control pattern, when the actual increase amount is larger than the reference increase amount, the correcting means corrects the target speed equivalent value at the predetermined control cycle in a manner where the larger the difference between the actual increase amount and the reference increase amount is, the larger the target speed equivalent value becomes.

5. The control apparatus of the motor for anti-skid control according to claim 1, wherein the correcting means sets a time period during which the target speed equivalent value has been corrected in a manner where the larger the difference between the actual increase amount and the reference increase amount is, the shorter the time period during which the target speed equivalent value has been corrected becomes.

6. The control apparatus of the motor for anti-skid control according to claim 4, wherein the correcting means corrects the target speed equivalent value when the actual increase amount is equal to or larger than the reference increase amount.

7. The control apparatus of the motor for anti-skid control according to claim 2, wherein the actual interval is a duration of time from a starting point of the pressure reducing control of an predetermined control cycle of the anti-skid control to a starting point of the pressure reducing control of a next anti-skid control.

8. The control apparatus of the motor for anti-skid control according to claim 4, wherein the actual increase amount is an amount of the brake fluid from a starting point of the pressure reducing control to an ending point of the pressure reducing control.

9. A hydraulic brake apparatus comprising:
an anti-skid control apparatus for executing an anti-skid control executing a pressure reducing control for reducing wheel cylinder pressure at a wheel when a tendency toward a locking exists at the wheel and a pressure increasing control for increasing the wheel cylinder pressure when the tendency toward the locking at the wheel is eliminated by means of the pressure reducing control, the pressure reducing control and the pressure increasing control being executed for plural control cycles;
a pump discharging the brake fluid, which is drained into a reservoir when the pressure reducing control for reducing the wheel cylinder pressure is executed, into a hydraulic pressure circuit of the anti-skid control apparatus;
a motor for driving the pump;
calculating means for calculating a vehicle body deceleration corresponding value that is a value corresponding to a vehicle body deceleration of the vehicle during the anti-skid control is executed;
controlling means for: determining a target speed of the motor on the basis of a characteristic where the brake fluid drained into the reservoir is increased as the calculated vehicle body deceleration corresponding value is increased; and controlling the speed of the motor on the basis of a target speed equivalent value that is equivalent to the determined target speed; and
correcting means for correcting the target speed on the basis of a difference between a reference control pattern and an actual control pattern, when a condition indicating that the difference exists between the reference control pattern of the anti-skid control on the basis of the determined target speed and the actual control pattern of the anti-skid control that is actually executed is detected.
